(19) United States
(12) Patent Application Publication
(10) Pub. No.: US 2011/0314288 A1
(43) Pub. Date: Dec. 22, 2011

(54) CIRCUIT, SYSTEM, DEVICE AND METHOD OF AUTHENTICATING A COMMUNICATION SESSION AND ENCRYPTING DATA THEREOF

(76) Inventor: Yoav Yogev, Mazkeret-Batya (IL)

(21) Appl. No.: 13/148,321

(22) PCT Filed: Feb. 8, 2010
(86) PCT No.: PCT/IB10/50564

§ 371 Date: Aug. 8, 2011

Related U.S. Application Data
(60) Provisional application No. 61/150,766, filed on Feb. 8, 2009.
(60) Provisional application No. 61/219,805, filed on Jun. 24, 2009.

(51) Int. Cl. H04L 9/32

(52) U.S. Cl. 713/172; 726/9

(57) ABSTRACT

Disclosed is a circuit, system, device and method for authentication and/or encryption, which is based on the characteristics and/or management of One Time Programming (OTP) Non Volatile Memory (NVM) that may prevent the ability to alter, modify, mimic or otherwise use an identification string/code for attaining false authentication and/or falsely decrypting encrypted data.

### FIELD OF THE INVENTION

The present invention generally relates to the field of Communication Authentication. More specifically, the present invention relates to a circuit, system, device and method for device and/or content identification and authentication and/or encryption based on ‘One Time Programming’ (OTP) NVM memory.

### BACKGROUND

Authentication is the process of determining whether someone or something is, in fact, who or what it is declared to be. In private and public computer networks (including the Internet), authentication is commonly done through the use of logon passwords. Knowledge of the password is assumed to guarantee that the user is authentic. Each user registers initially (or is registered by someone else), using an assigned or self-declared password. On each subsequent use, the user must know and use the previously declared password. The weakness in this system for transactions that are significant (such as the exchange of money) is that passwords can often be stolen, accidentally revealed, or forgotten.

For this reason, Internet business and many other transactions require a more stringent authentication process. The use of digital certificates issued and verified by a Certificate Authority (CA) as part of a public key infrastructure is considered likely to become the standard way to perform authentication on the Internet.

There are three main factors of authentication to consider: something you know, such as a user ID and password; something you have, such as a smart card; and something you are, which refers to a physical characteristic, like a fingerprint that is verified using biometric technology. These factors can be used alone, or they can be combined to build a stronger authentication strategy in what is known as two-factor or multifactor authentication.

User ID and password systems are among the oldest forms of digital authentication. These types of authentication systems, which simply prompt a user to enter his or her ID and password to gain system access, are easy to implement and use, but they also carry some huge security risks.

One of the biggest problems with passwords is that they can be shared, guessed or misused. Organizations educate users on how to properly handle their passwords. Among the most important password guidelines for users is that passwords should never been written down. Often employees will jot down their passwords in an effort to help them remember their many sets of credentials. One way to eliminate this problem is to nix the use of multiple passwords. If users can have one ID and password for corporate systems—typically referred to as enterprise single sign-on (SSO)—the likelihood of them needing to jot anything down is greatly decreased.

Biometrics is an authentication method that uses fingerprint or facial scans and iris or voice recognition to identify users. A biometric scanning device takes a user's biometric data, such as an iris pattern or fingerprint scan, and converts it into digital information a computer can interpret and verify. Since it is more difficult for a malicious hacker to gain access to a person's biometric data, and it is unlikely that a user will misplace or misuse his or her biometric data, this form of technology a greater level of assurance than other methods of identification.

Biometrics can be used for both physical access to corporate buildings and internal access to enterprise computers and systems. Biometrics is most often used as a form of authentication in a broader two-factor or multifactor authentication

Single sign-on (SSO) is a form of technology that eases the authentication process for users and IT administrators. Through SSO, a user can enter his or her username and password once for access to multiple applications. Users are given rights to specific applications, and they will be able to access all of those apps when they enter their credentials, which eliminates continuous prompts. SSO also reduces the cost of managing an endless number of passwords for IT staffs.

SSO systems improve security by centralizing authentication on dedicated servers. All authentication credentials must travel through a dedicated SSO server first, which then passes along the specific authentication credential it has stored for an individual user. This centralization is more likely to weed out malicious access than single-factor authentication systems.

A public key infrastructure (PKI) is a group of servers that handle the creation of public keys for digital certificates. PKI systems maintain digital certificates, creating and deleting them as needed. The system allows users to swap information securely across a public network through a pair of public and private cryptographic keys, which is obtained and accessed through a certificate authority (CA). The public key infrastructure provides a digital certificate, which is an electronic “credit card” that contains the name of the certificate authority, the name of the user, and the effective and expiration dates and the user's public key. Digital certificates are used to establish user credentials during online transactions. All certificates are issued by a certification authority and contain the digital signature of the certificate-issuing authority to verify authentication.

A smart card is a small plastic card, about the size of a credit card, containing an embedded microchip that can be programmed to store specific user authentication information. The chip on a smart card can store multiple identification factors of a specific user (i.e. password and fingerprint). When the user swipes his or her card into a smart card reader, the card implements multiple factors of authentication, making the smart card system a viable option for two-factor or multifactor authentication.

In connection with secure transactions and secure communication sessions (e.g. entered into through distributed communication networks). Authentication may be of a string or code (e.g. login id) and not of the actual device or person behind it. This requirement may pose a problem to proprietary hardware authentication solutions as they attempt to identify the real device/person behind a virtual identity.

Accordingly, there is a need in the field for a circuit, system device and method for authentication and/or encryption that may mitigate the possibility of false positive identification based on cloning an identifying device or identification code(s) and eliminate the threat of hackers stealing stored or transmitted information from a computer. The information may be fully or partially processed on the smart card, so some or all of it may never have to leave the card or be transmitted to another machine.

In connection with secure transactions and secure communication sessions entered into through distributed communication networks, authentication is required in order to verify that a virtual identity requesting a session (e.g. party requesting connection with a secure server or gateway) is the original registering identity. Authentication may be of a string or code (e.g. login id) and not of the actual device or person behind it. This requirement poses a problem to most proprietary hardware authentication solutions as they attempt to identify the real device/person behind a virtual identity.

Accordingly, there is a need in the field for a circuit, system and method for authentication and/or encryption that may mitigate the possibility of false positive identification based on cloning an identifying device or identification code(s).

### SUMMARY OF THE INVENTION

The present invention is a circuit, system and method of authenticating a communication session between a Non-Volatile Memory (NVM) array and one or more hosts, between a computing and/or communication device and a host, between a computing and/or communication device and a communication gateway associated with a data server and/or for the authentication of a communication session and/or authenticated transaction with an application (e.g. authentication of a licensed product's certification) based on one or more identification strings, such as a chip serial number or a user identification number, which may be written to a One Time Programming (OTP) portion of an NVM array. According to some embodiments of the present invention, there may be provided a peripheral device including a host interface circuit and Non-Volatile Memory (NVM) array, where one or more identification strings, such as a chip serial number or a user identification number, may be written to a One Time Programming (OTP) portion of the array. An NVM controller functionally associated with the array may be configured to tag or otherwise recognize the one or more identification string(s) written to the OTP portion of the array as one or more factors in a single or multi-factor authentication scheme.

A NVM Controller according to some embodiments of the present invention, may reside on the same die as the array and may be adapted, possibly by being functionally associated with a further NVM control logic, to track which addresses of the OTP portion of the array have been written to, and may further be adapted to remove the written to addresses of the array from a table of possible data storage locations for new data. Alternatively, addresses of array OTP locations to which data was written may be added to a “No Write” table. Alternatively, OTP data may be written serially, and a counter may be used to track and identify array locations to which data may still be written. According to yet further embodiments of the present invention, the controller may be adapted to check a location on the OTP portion of the array (e.g. a page of array) and to determine whether that location has already been written to—in which event the controller may block further writing to that location. Any method, circuit or technique for achieving OTP functionality in an NVM array, known today or to be devised in the future, may be applicable to the present invention. Furthermore, the NVM controller may also be adapted to inhibit/disable formatting or erasing (e.g. flash an NVM block) of written to locations of the OTP portions of the array.

According to further embodiments of the present invention, some or all of the OTP functionality described may also be implemented by a system level controller within the peripheral device and functionally associated with the NVM array.

According to further embodiments of the present invention, authentication logic functionally associated with the NVM controller may access and utilize the one or more identification strings in response to an authentication query. Furthermore, encryption logic functionally associated with the NVM controller may access and utilize one or more of the identification strings in support of an encrypted communication session (e.g. between the Non-Volatile Memory (NVM) die and the currently hosting device, between the currently hosting device and a remote communication gateway with which the host device is communicating through a network) wherein at least part of the encryption scheme is based on data derived from the OTP portion of the NVM array.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying attachments including drawings:

FIG. 1 shows a basic exemplary system configuration of a system for authenticating a communication session between a Non-Volatile Memory (NVM) array and one or more hosts, in accordance with some embodiments of the present invention;

FIG. 2A shows a partial exemplary system configuration of a system for authenticating a communication session between a Non-Volatile Memory (NVM) array and one or more hosts wherein the NVM Controller is adapted to remove written to One Time Programmable (OTP) portion addresses of the NVM array from a table of possible data storage locations for new data, in accordance with some embodiments of the present invention;

FIG. 2B shows a partial exemplary system configuration of a system for authenticating a communication session between a Non-Volatile Memory (NVM) array and one or more hosts wherein the NVM Controller is adapted to add addresses of array OTP locations to which data was written to a “No Write” table, in accordance with some embodiments of the present invention;

FIG. 2C shows a partial exemplary system configuration of a system for authenticating a communication session between a Non-Volatile Memory (NVM) array and one or more hosts wherein OTP data is written serially and a counter is used to track and identify array locations to which data may still be written, in accordance with some embodiments of the present invention;

FIG. 3A shows the first main stage of a multi-level multi-component authentication and encryption scheme between an OTP NVM circuit a Content-Owner Loading Tool used for programming/writing data onto the NVM die of the OTP NVM circuit and a Host used for playback/presentation/output of data programmed/written onto the NVM die, in accordance with some embodiments of the present invention;

FIG. 3B shows the second and third main stages of a multi-level multi-component authentication and encryption scheme between an OTP NVM circuit a Content-Owner Loading Tool used for programming/writing data onto the NVM die of the OTP NVM circuit and a Host used for playback/presentation/output of data programmed/written onto the NVM die, in accordance with some embodiments of the present invention;

FIG. 4A shows an exemplary encrypted communication session between a hosting device and a remote communication gateway with which the host device is communicating through a network, in accordance with some embodiments of the present invention;

FIG. 4B shows an exemplary encrypted communication session, wherein the encryption is also partly based on personal identification data of the computing and/or communication device user, and/or the peripheral device user, in accordance with some embodiments of the present invention;

FIG. 4C shows an exemplary encrypted communication session, wherein the encryption engine includes a time-dependent component (e.g. Real Time Clock (RTC) and a battery), in accordance with some embodiments of the present invention;

FIG. 5 shows an exemplary authentication scheme using a combination of two or more identification strings, where a first identification string is stored on a computing and/or communication device used as an interface to the transaction system, and where a second identification string is stored on the peripheral device hosted by the computing and/or communication device, in accordance with some embodiments of the present invention;

FIG. 6 shows an exemplary authentication scheme wherein one or more identification strings stored on the OTP memory are used as part of an authentication or authorization scheme associated with a local application, such as an application running on the currently hosting device, in accordance with some embodiments of the present invention;

FIG. 7 shows a basic exemplary system configuration, of a system for authentication and encryption between a gaming console cartridge and a gaming console, in accordance with some embodiments of the present invention;

FIG. 8A shows an exemplary challenge-response based mutual authentication scheme wherein a gaming console and a gaming cartridge may authenticate each other, in accordance with some embodiments of the present invention;

FIG. 8B shows an exemplary encryption scheme between a gaming console and a gaming cartridge, in accordance with some embodiments of the present invention;

FIG. 9 shows some of the exemplary peripheral devices/circuits that may be functionally associated with a host's corresponding interface circuits, in accordance with some embodiments of the present invention;

FIG. 10 shows a flowchart of the steps executed by an exemplary peripheral devices system controller acting as a ‘master’ which triggers application activation on its host device, in accordance with some embodiments of the present invention;

FIG. 11A shows an exemplary peripheral device that includes a non-OTP memory portion, wherein data received by the peripheral device from the host is stored on the non-OTP memory portion, in accordance with some embodiments of the present invention;

FIG. 11B shows an exemplary peripheral device that includes a non-OTP memory portion, wherein one or more identification strings are used by the peripheral device encryption engine to encrypt and/or digitally sign data received from the host device, in accordance with some embodiments of the present invention;

FIG. 11C shows an exemplary peripheral device that includes a non-OTP memory portion, wherein the peripheral device includes an interface slot and circuit adapted to receive an external memory card (e.g. SD card) and store data received from the host onto a card inserted into the slot, in accordance with some embodiments of the present invention; and

FIG. 12 shows a flowchart of the steps executed by an exemplary system configuration wherein one or more new identification strings are added to the OTP portion of the NVM array, in accordance with some embodiments of the present invention.

### DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

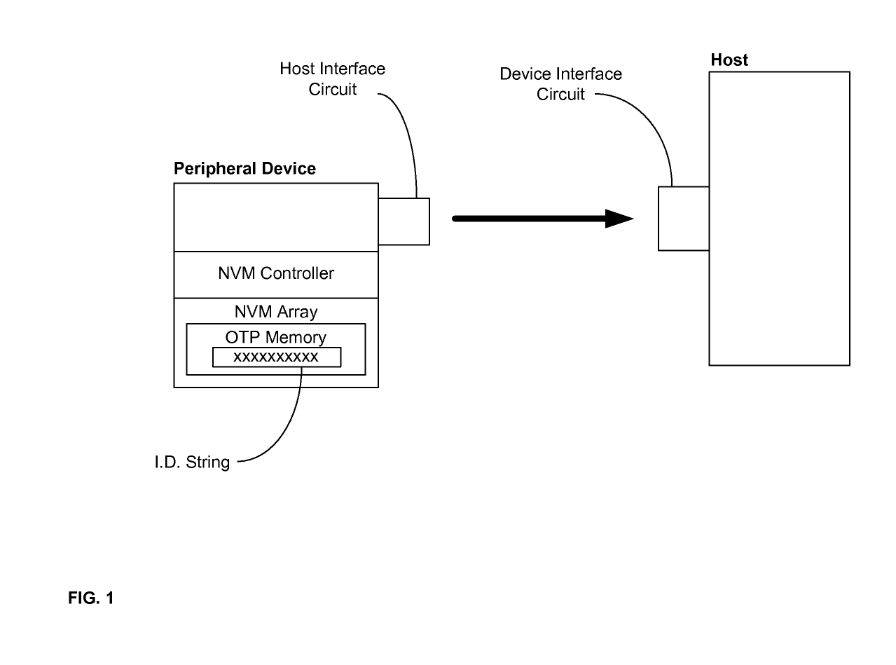

The present invention is a circuit, system and method of authenticating a communication session between a Non-Volatile Memory (NVM) array and one or more hosts, between a computing and/or communication device and a host, between a computing and/or communication device and a communication gateway associated with a data server and/or for the authentication of a communication session and/or authenticated transaction with an application (e.g. authentication of a licensed product's certification) based on one or more identification strings, such as a chip serial number or a user identification number, which may be written to a One Time Programming (OTP) portion of an NVM array. According to some embodiments of the present invention, there may be provided a peripheral device including a host interface circuit and Non-Volatile Memory (NVM) array, where one or more identification strings, such as a chip serial number or a user identification number, may be written to a One Time Programming (OTP) portion of the array. An NVM controller functionally associated with the array may be configured to tag or otherwise recognize the one or more identification string(s) written to the OTP portion of the array as one or more factors in a single or multi-factor authentication scheme (FIG. 1).

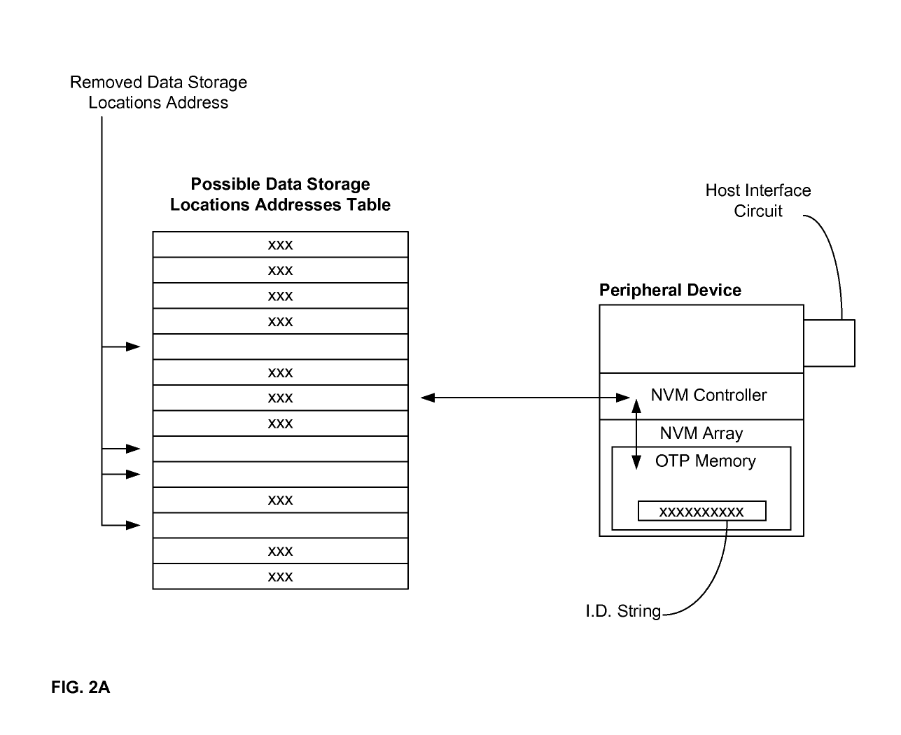

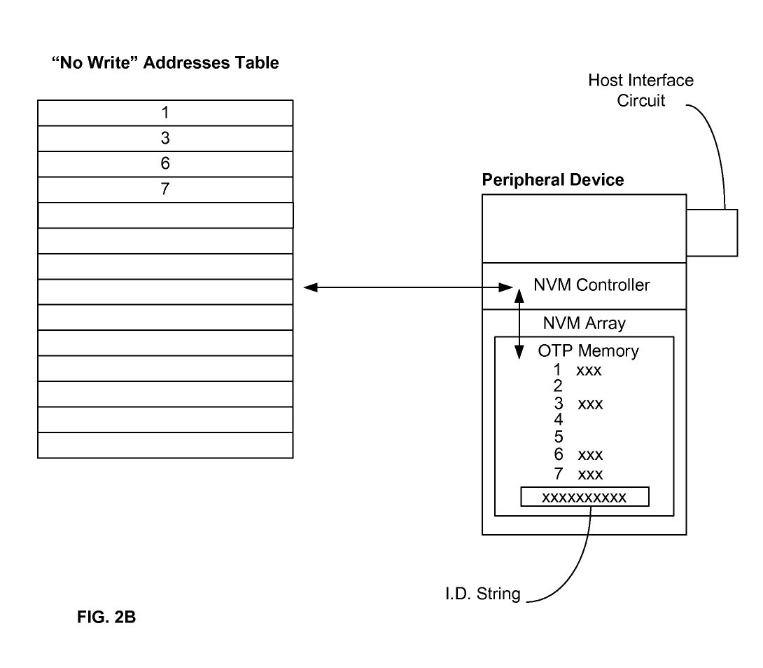

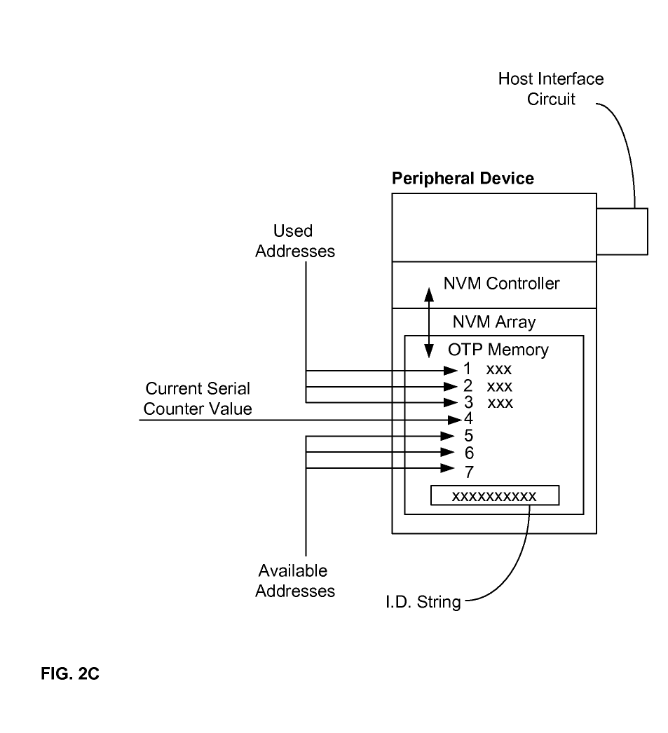

A NVM Controller according to some embodiments of the present invention may reside on the same die as the array, may be adapted to track which addresses of the OTP portion of the array have been written to, and may further be adapted to remove the written to addresses of the array from a table of possible data storage locations for new data (FIG. 2A). Alternatively, addresses of array OTP locations to which data was written may be added to a “No Write” table (FIG. 2B). Alternatively, OTP data may be written serially, and a counter may be used to track and identify array locations to which data may still be written (FIG. 2C). According to yet further embodiments of the present invention, the controller may be adapted to check a location on the OTP portion of the array (e.g. a page of array) and to determine whether that location has already been written to—in which event the controller may block further writing to that location. Any method, circuit or technique for achieving OTP functionality in an NVM array, known today or to be devised in the future, may be applicable to the present invention. Furthermore, the NVM controller may also be adapted to inhibit/disable formatting or erasing (e.g. flash an NVM block) of written to locations of the OTP portions of the array.

According to further embodiments of the present invention, some or all of the OTP functionality described may also be implemented by a system level controller within the peripheral device and functionally associated with the NVM array.

According to further embodiments of the present invention, authentication logic functionally associated with the NVM controller may access and utilize the one or more identification strings in response to an authentication query. Furthermore, encryption logic functionally associated with the NVM controller may access and utilize one or more of the identification strings in support of an encrypted communication session (e.g. between the Non-Volatile Memory (NVM) die and the currently hosting device, between the currently hosting device and a remote communication gateway with which the host device is communicating through a network) wherein at least part of the encryption scheme is based on data derived from the OTP portion of the NVM array.

The following is an exemplary embodiment, in accordance with some embodiments of the present invention, of a multi-level multi-component authentication and encryption scheme between an OTP NVM circuit a Content-Owner Loading Tool used for programming/writing data onto the NVM die of the OTP NVM circuit and a Host used for playback/presentation/output of data programmed/written onto the NVM die. It should be clear that various authentication and/or encryption sub-schemes, which comprise this multi-level multi-component authentication and encryption scheme, may be used and/or utilized separately or as part of a number of possible combinations, as part of an authentication and/or encryption scheme. Furthermore, various systems comprising OTP NVM, including, but in no way limited to: OTP NVM circuit, SD card (with controller), USB pen drive (with controller), bare OTP die, etc. may be utilized as to implement one or more of these schemes.

when implemented by a System/Card Level Controller within the peripheral device (e.g. SD card) which is functionally associated with the NVM array, some or all communication between the memory and the Host may be “tunneled” via the System/Card Level Controller without sharing data/secrets with the controller and/or controller-manufacturer (e.g. the controller cannot reveal the encryption keys, hence cannot decrypt the data).

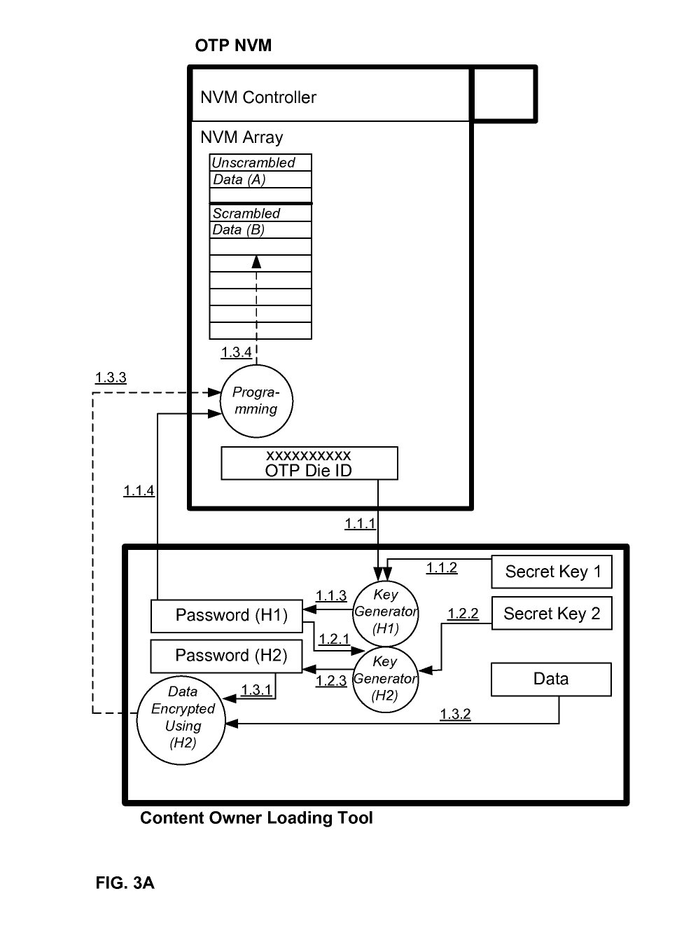

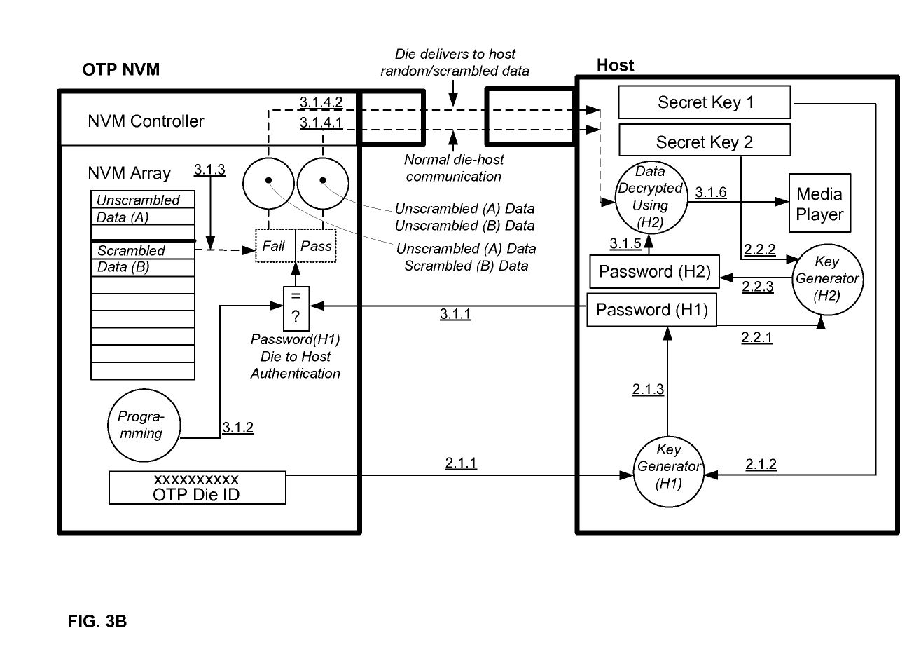

Reference is now made to FIG. 3A (FIG. 3A) where the first main stage of this exemplary authentication and encryption scheme is presented. According to some embodiments of the present invention, a Content Loading Tool (e.g. a content owner's loading tool/host) may request the OTP Die ID, written to the OTP section of a NVM Array, from the NVM Controller. The Content Loading Tool may comprise a Key Generator adapted to utilize the received OTP Die ID (1.1.1) along with a First Secret Key (1.1.2) possessed by the Content Loading Tool for calculating a Content Loading Tool's First Password (e.g. Hash Value) (1.1.3). The calculated Content Loading Tool's First Password may then be communicated to, and programmed onto the OTP section of the NVM array (1.1.4).

According to some embodiments of the present invention, the Key Generator may be adapted to utilize the calculated Content Loading Tool's First Password (1.2.1) along with a Second Secret Key possessed by the Content Loading Tool (1.2.2) for calculating a Content Loading Tool's Second Password (e.g. Hash Value) (1.2.3). The calculated Content Loading Tool's Second Password may be utilized as part of an encryption scheme (1.3.1), for encrypting data, possessed by the Content Loading Tool (1.3.2). The encrypted data may then be communicated to, and programmed onto the OTP section of the NVM array (1.3.3). According to some embodiments, the Content Loading Tool may be capable of loading private/specific data per NVM die/card (e.g. according to die's/card's ID).

Reference is now made to FIG. 3B (FIG. 3B) where the second and third main stages of this exemplary authentication and encryption scheme is presented. According to some embodiments of the present invention, upon connection of the NVM array to a Host and/or power-up of a Host to which the NVM array has been connected, the host may request the OTP Die ID, written to the OTP section of the NVM array, from the NVM controller. The Host may comprise a Key Generator, similar to the Content Loading Tool's Key Generator, adapted to utilize the received OTP Die ID (2.1.1) along with a First Secret Key (2.1.2), similar to the Content Loading Tool's First Secret Key, possessed by the Host for calculating a Host's First Password (e.g. Hash Value) (2.1.3).

According to some embodiments of the present invention, the Host's Key Generator may be adapted to utilize the calculated Host's First Password (2.2.1) along with a Second Secret Key (2.2.2), similar to the Content Loading Tool's Second Secret Key, possessed by the Host for calculating a Host's Second Password (e.g. Hash Value) (2.2.3).

According to some embodiments of the present invention, the calculated Host's First Password may be communicated to the NVM Controller (3.1.1) and compared to the Content Loading Tool's First Password programmed onto the OTP section of the NVM array (3.1.2). A Host's First Password which is similar to the Content Loading Tool's First Password may indicate that both First Passwords were generated based on similar First Secret Keys, the OTP Die ID of the same die or set of dies, and were calculated by similar Key Generators. Accordingly, a positive die to host authentication (Pass) may be established. Any, one or more (various authentication levels, or authentications based on various levels of password similarity may be implemented), dissimilarities between the Host's First Password and the Content Loading Tool's First Password may result in a negative die to host authentication (Fail).

According to some embodiments of the present invention, the NVM controller may be adapted to program/read, the encrypted data communicated to, and programmed onto the OTP section of the NVM array, in a scrambled format (3.1.3). Upon a positive die to host authentication, data may be unscrambled prior to its communication to the Host (3.1.4.1), alternatively, upon a negative die to host authentication data may be sent to the Host in its original scrambled format (3.1.4.2). According to some embodiments of the present invention, certain one or more sections (e.g. all array addresses higher than a certain value) of the OTP NVM may be designated as Scrambled Data Sections, from which the NVM Controller may read data in a scrambled format. According to some exemplary embodiments of the present invention, the initial locations/addresses of the one or more Scrambled Data Sections may be determined by the data owner, according to further exemplary embodiments of the present invention, the locations/addresses of the one or more Scrambled Data Sections may be dynamically changed during operation by the Host/NVM Controller.

According to some embodiments of the present invention, the calculated Host's Second Password may be utilized as part of an encryption scheme, for decrypting the encrypted data, programmed onto the OTP section of the NVM array, when read by host (3.1.5). A Host's Second Password which is similar to the Content Loading Tool's Second Password, and may thus enable the encrypted data's decryption, may indicate that both First Passwords were generated based on similar First Secret Keys, the OTP Die ID of the same die or set of dies, and were calculated by similar Key Generators; furthermore, it may indicate that both the Host's and the Content Loading Tool's Second Secret Keys are similar. Decrypted data may then be communicated to the media player for playback/presentation/output (3.1.6).

According to some embodiments of this example, Password (H2) may remain solely in the possession of the host(s) and may never be communicated on the data lines nor stored on the NVM.

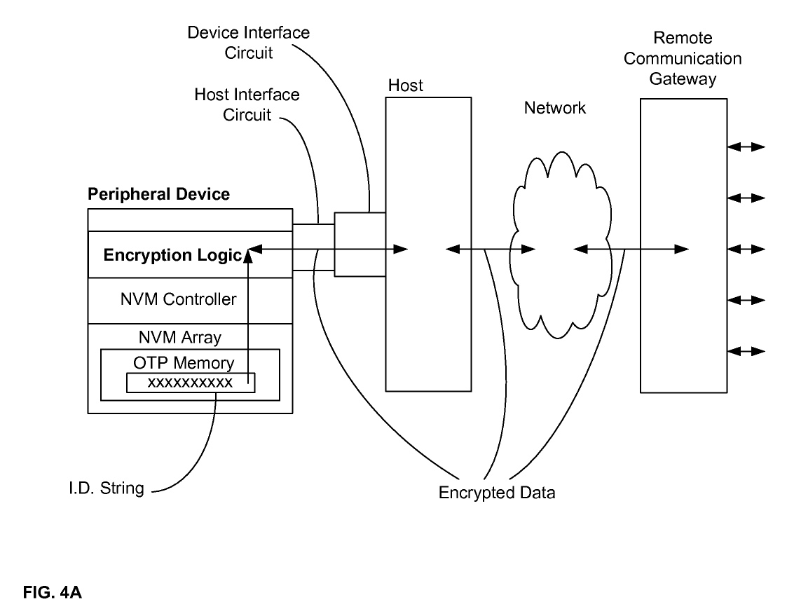

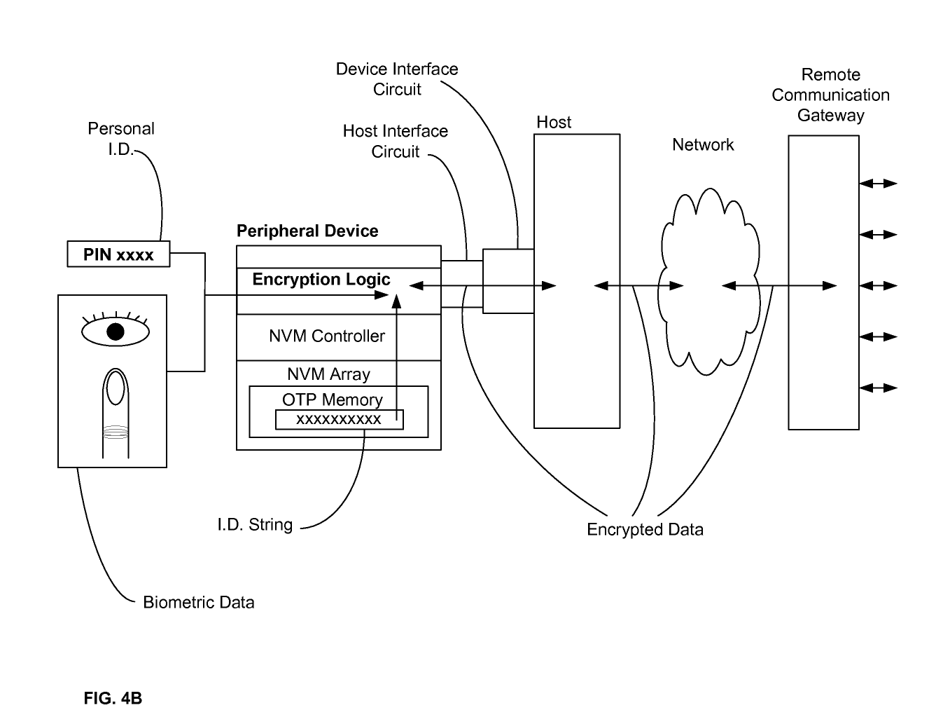

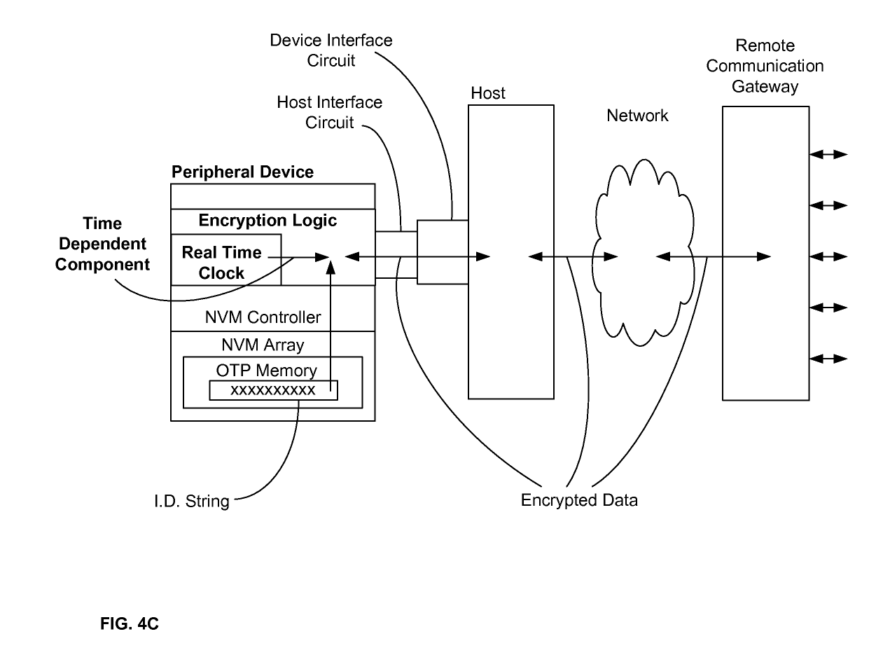

According to some embodiments of the present invention, an encrypted communication session may take place between the currently hosting device and a remote communication gateway with which the host device is communicating through a network (FIG. 4A). According to further embodiments of the present invention, the encryption may also be partly based on personal identification data of the computing and/or communication device user, and/or the peripheral device user (e.g. Personal Identification Number (PIN), fingerprint data, voice print data, or any other biometric data) (FIG. 4B). According to further embodiments of the present invention, the encryption engine may include a time-dependent component (e.g. Real Time Clock (RTC) and a battery) (FIG. 4C), such that the data stream cannot be replayed or repeated by an attacker.

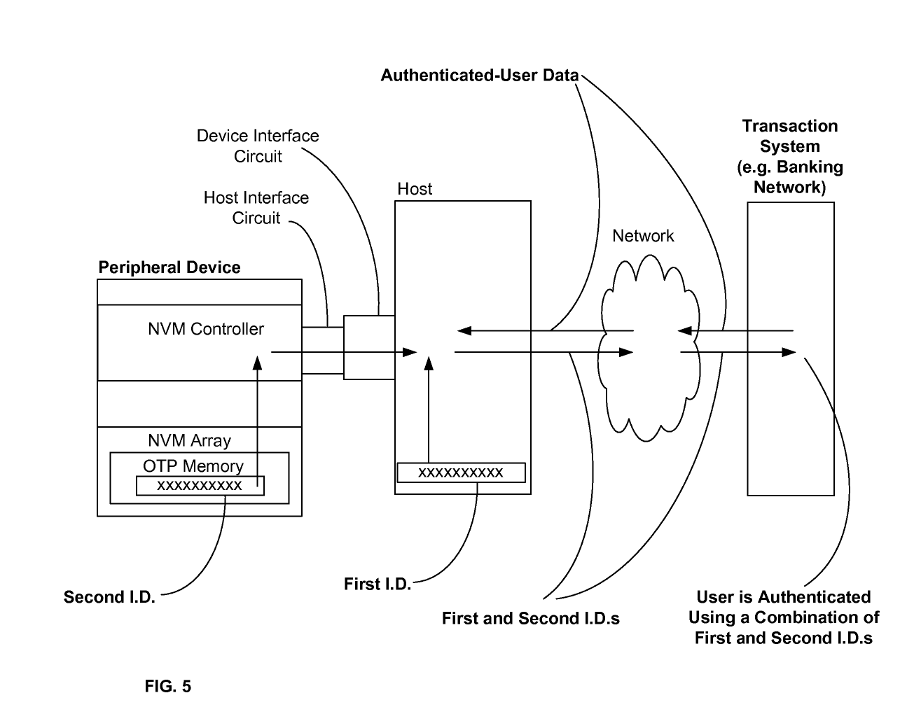

According to some embodiments of the present invention, a user engaging in a transaction associated with a given transaction system (e.g. a banking network) and requiring authentication may be authenticated using a combination of two or more identification strings, where a first identification string may be stored on a computing and/or communication device used as an interface to the transaction system, and where a second identification string may be stored on the peripheral device hosted by the computing and/or communication device (FIG. 5).

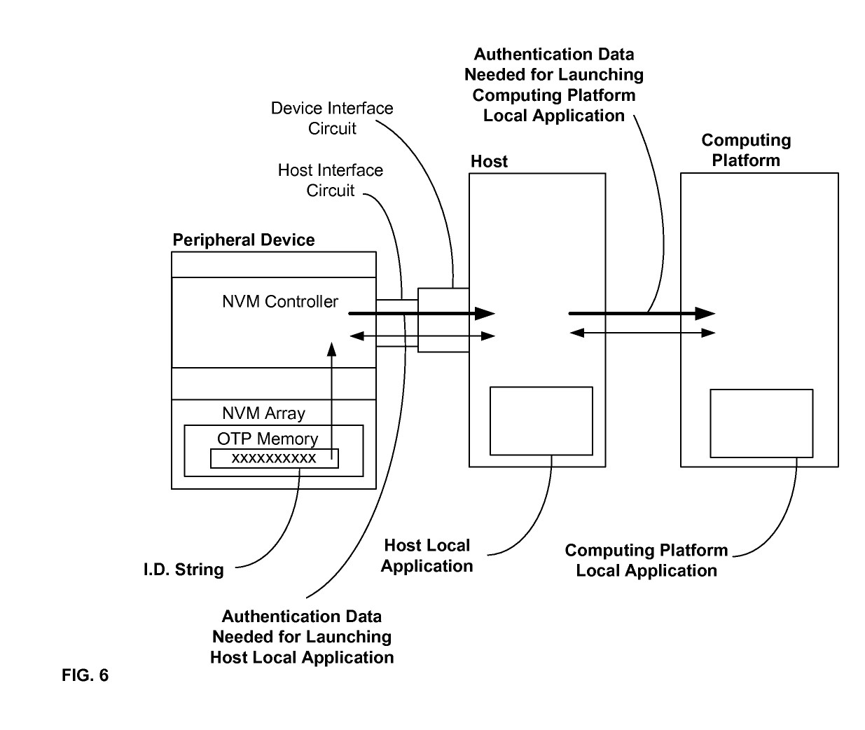

According to further embodiments of the present invention, the one or more identification strings stored on the OTP memory may be used as part of an authentication or authorization scheme associated with a local application, such as an application running on the currently hosting device or applications running on computing platforms directly connected to the currently hosting device (FIG. 6).

According to alternative embodiments of the present invention, the peripheral device and the host computing and/or communication devices may authenticate each other. According to some further embodiments of the present invention, the mutual authentication process may not require the computing and/or communication device to receive the identification string stored on the peripheral device, but rather may consist of challenge based authentication. For example, according to some embodiments of the present invention, the controller of the peripheral device may be configured such that data access for reading the OTP data is limited to the encryption/authentication logic functionally associated with the peripheral. Accordingly, a given peripheral device may never disclose its identification string to any of its one or more hosting, computing and/or communication devices.

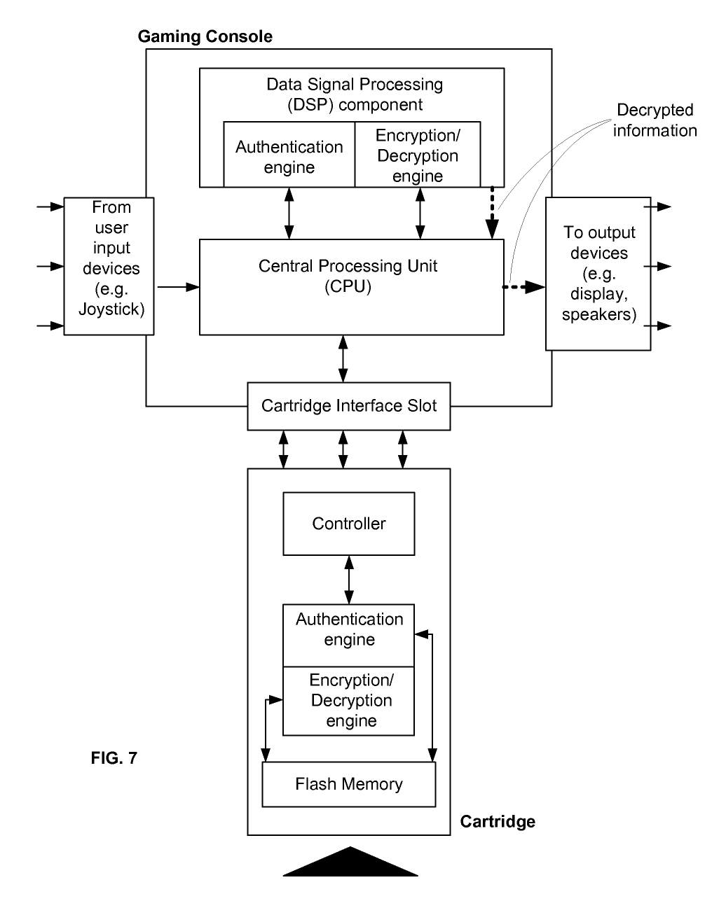

In the following exemplary embodiment of the present invention, identification strings stored on OTP memory are used as part of an authentication, authorization and/or encryption scheme associated with a local application. In this exemplary embodiment, a data storage device such as a gaming console cartridge is adapted to store game code to be executed on the gaming console. The storage device may include an authentication engine, an encryption/decryption engine, and the game code data stored on the device, which may be stored in an encrypted form. The host, a gaming console, may likewise include an authentication engine and an encryption/decryption engine (FIG. 7).

According to this exemplary embodiment of the present invention, upon an interconnection of the data storage device with the gaming console, an authentication scheme may be initiated. The authentication scheme may be a phase or a layer in a multi level security configuration. Either the device's authentication engine or the console's authentication engine may provide one or more factors associated with a multifactor authentication scheme.

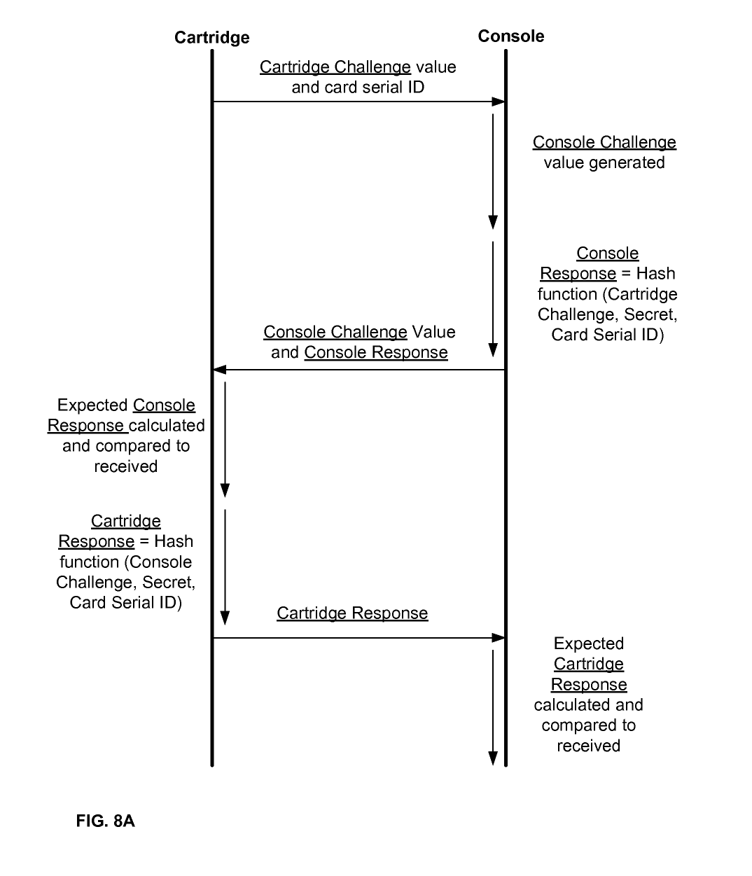

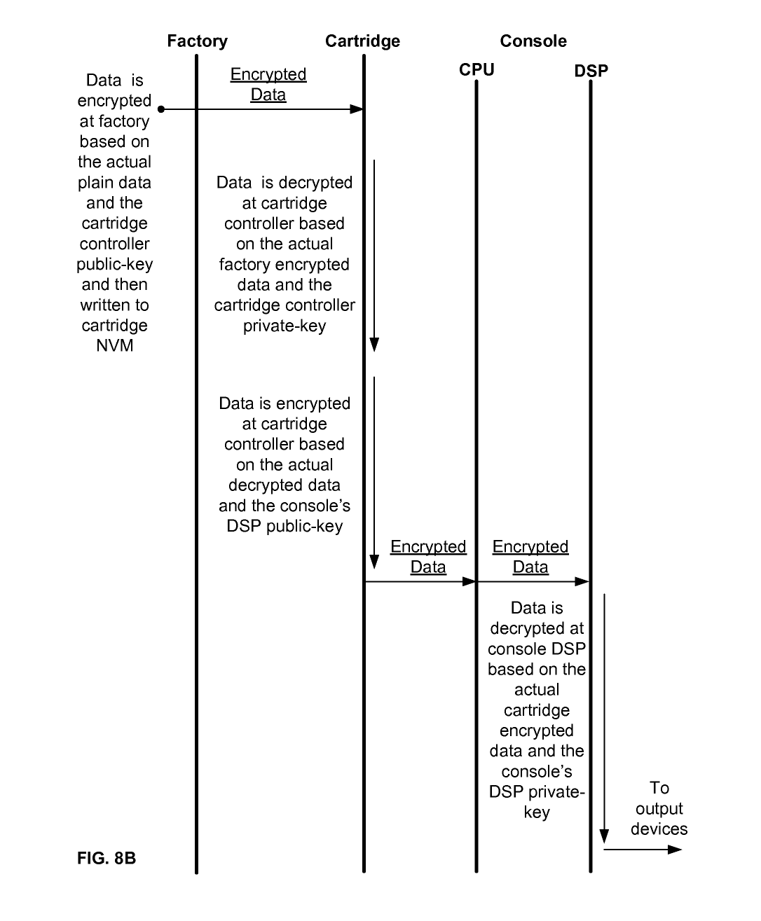

Both, the console and the cartridge may authenticate each other, as part of a challenge-response based mutual authentication scheme such as the exemplary scheme shown in (FIG. 8A). According to this exemplary embodiment of the authentication scheme, the data storage device authentication engine may send a unique device challenge value and the serial ID of the device card to the console authentication engine. The console authentication engine may then generate a console challenge value, and may compute a console response value by executing a hash function on the cartridge challenge value, an additional secret (e.g. function, template, code, string) it holds, and the serial ID of the device card; and, may then send back to the storage device both the console challenge value and the computed console response value. The data storage device authentication engine may then calculate the expected console response value and compare it to the one received from the console authentication engine to ensure they are identical, and compute its cartridge response by executing a hash function on the console challenge value, an additional secret (e.g. function, template, code, string) it holds, and the serial ID of the device card. The data storage device authentication engine may then send the calculated cartridge response value back to the console authentication engine, where it may be compared to the expected storage device response value calculated by the console authentication engine to ensure they are identical. The scheme described may be repeated until the aspired security level is achieved.

As described in the above exemplary embodiment, both the console and the cartridge may verify each other using a challenge-response based authentication. Accordingly, both cartridge and console authenticity may be obtained, wherein an unauthorized cartridge may fail to communicate with any, authorized or unauthorized, console; and/or an unauthorized console may fail to communicate with any, authorized or unauthorized cartridge. The challenge-response authentication may further prevent replay type attack attempts wherein real packets are recorded and later played-backed to an authentic cartridge's authentication engine; and/or brute force type attack attempts that may try various, or all possible, passwords as to mimic a genuine console and obtain false authentication with the cartridge, thus revealing cartridge stored data.

Upon an interconnection of the data storage device with the gaming console an encrypted communication session may be established between a controller of the device and a controller of the console. The encrypted communication session may be a phase or a layer in a multi level security configuration. Respective encryption/decryption engines on the device and the console may be used to establish the encrypted communication sessions.

According to this exemplary embodiment, of an encryption scheme, in accordance with the present invention and as shown in (FIG. 8B), data may be initially encrypted at the factory, based on the actual plain data and the cartridge controller public-key, and then written to the cartridge NVM. Data travelling from the cartridge's NVM in an encrypted format, may later be decrypted at the cartridge controller, based on the actual factory encrypted data and the cartridge controller private-key. A second encryption may take place at the cartridge controller based on the actual cartridge decrypted data and the console's Data Signal Processing (DSP) public-key, such that data travelling to the console's CPU and on to its DSP is also encrypted. Upon arrival at the console's DSP, data is decrypted based on the actual cartridge encrypted data and the console's DSP private-key. Decrypted data, may now be safely sent to output devices (e.g. via the console's CPU) as no additional possible hacking points remain in its due route.

The storage device's encryption/decryption engine may scramble and/or encrypt the data and only then transmit it to the console. The decrypting code may be stored on both the storage device and the console, whereas the encryption code may be fetched by the console's encryption/decryption engine from the storage device's memory. Thus, a virtual private tunnel between the storage device and the console's DSP may be created by encryption of all data travelling through this path. As most or all substantially possible (e.g. hacker time and cost worthwhile) hacking points: (1) between the on-cartridge flash memory device (e.g. OTP) and the storage device controller; (2) between the storage device controller and the console's Central Processing Unit (CPU); and (3) between the console's CPU and DSP; are along that path, even a malicious successful data retrieval attempt will result in the retrieval of encrypted unusable data which may not assist the hack attempt. Solely data travelling the ‘last mile’ from the DSP back to the console's CPU and on to the output device(s) may be in a decrypted format, and as no possible hacking points are along that final route, it may not hinder the overall, encryption based, security level.

According to further embodiments of the present example, upon an interconnection of the data storage device with the gaming console, a data encryption on the memory storage level may be established between a controller of the storage device and a controller of the console, possibly through use of the aforementioned encrypted communication session. The data encryption on the memory storage level may be a phase or a layer in a multi level security configuration. Non-Volatile Memory (NVM) access control codes may be uploaded from the storage device to the console's processor. The codes may be processor specific and may only operate with a predefined set of game console processors. The NVM access control codes may also include decryption factors needed for decrypting code data stored on the device NVM. Using the received NVM access control codes, the processor may read and decrypt the game code data on the Device NVM. The decrypting code may be stored on both the cartridge and the console, whereas the encryption code may be fetched by the DSP from the cartridge memory. Accordingly, any direct read from the memory, which is not made by the genuine console, may result in random meaningless information.

Furthermore, part of the actual machine code (e.g. binary code) which is used by the console in order to read and execute the executable-game-code which is written to the cartridge may be written to the cartridge in an encrypted format. This may necessitate for both the console and cartridge to be genuine and/or to also include genuine components (e.g. a genuine console DSP) as even an attempt to execute a executable-game-code from a genuine cartridge, when made by a non-genuine console DSP, will cause the DSP to receive scrambled/encrypted machine code which it must, but cannot, use in order for it to be able to run said executable-game-code.

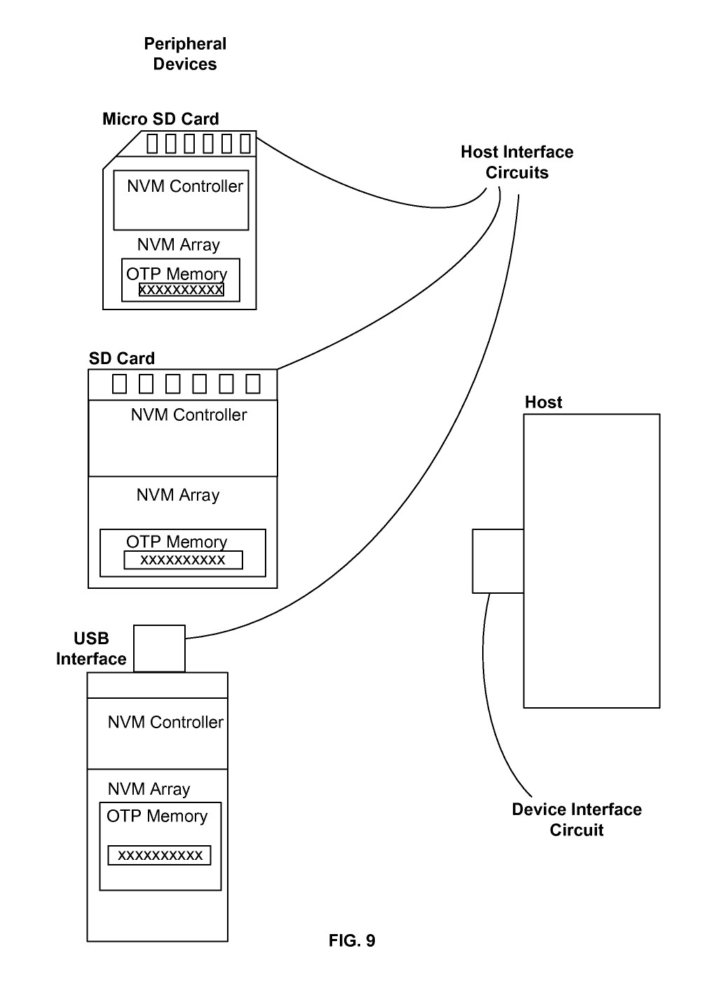

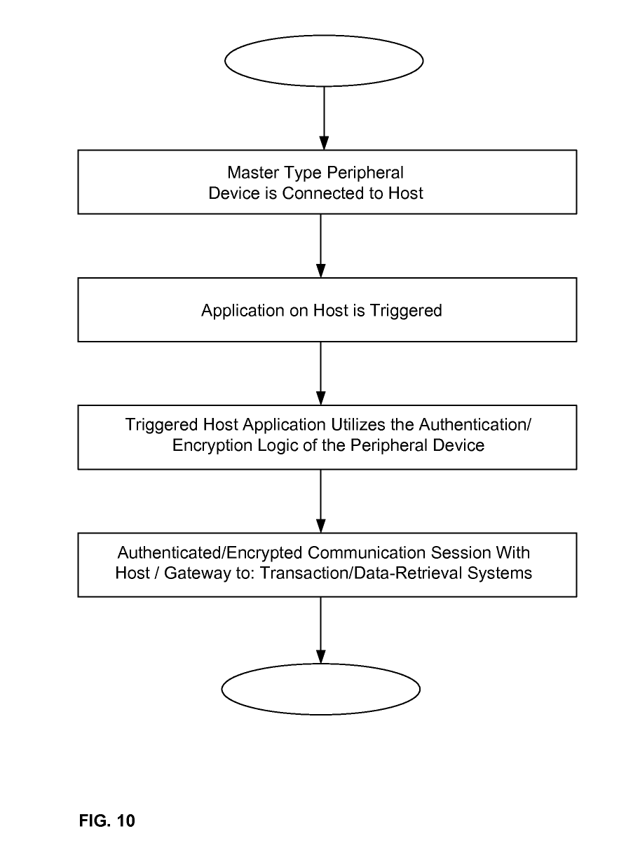

According to some embodiments of the present invention, the host interface circuit functionally associated with the peripheral device's controller circuit may be a Universal Serial Bus (USB) interface, a Secure Digital card (SD) interface, Micro SD card interface, etc. (FIG. 9). According to USB based embodiments of the present invention, the peripheral device's system controller may act as a ‘master’ USB and trigger application activation of the host device. The triggered application(s) may be adapted to utilize some or all of the authentication and/or encryption logic of the peripheral device in order to establish and/or to communicate with a remote communication gateway. The communication gateway may be a gateway to a transaction system or to a data retrieval system such as: medical systems or databases, personal data systems, user/device location based systems, surveillance systems, for the authenticated application activation or authenticated setting configuration of various systems and/or for any system requiring or benefiting from authenticated communication sessions (FIG. 10).

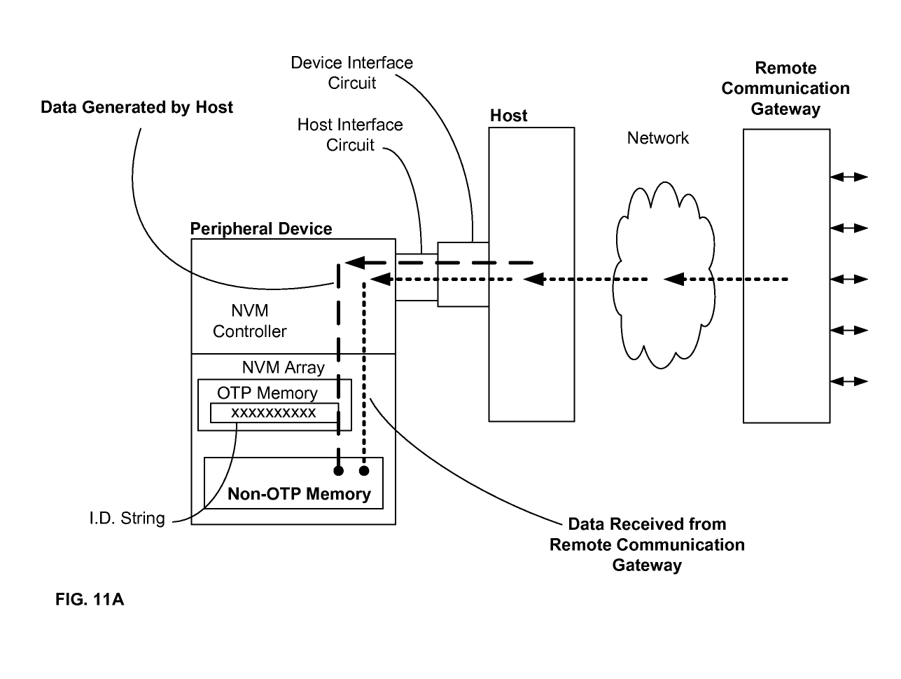

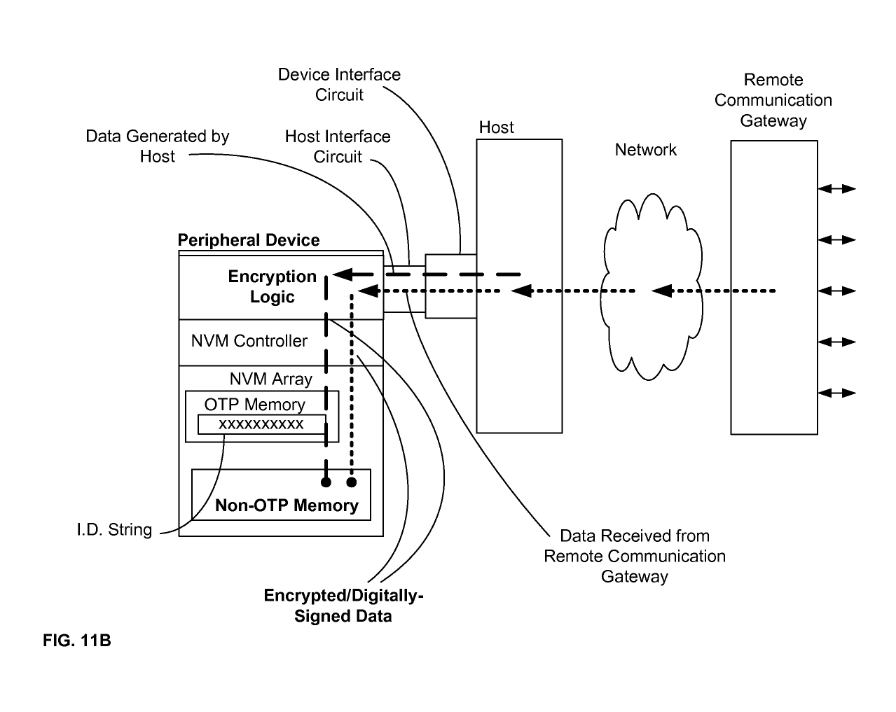

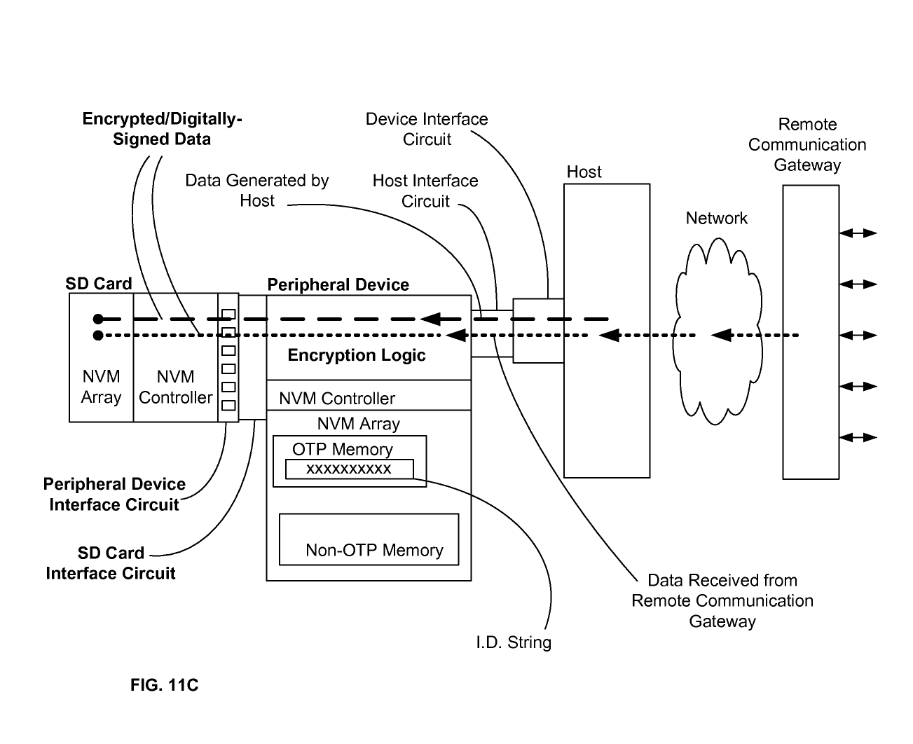

The peripheral device may further include a non-OTP memory portion, either on the same or on a different array as the OTP memory portion. Data received by the peripheral device from the host (e.g. data generated by the host or received from the remote gateway) may be stored on the non-OTP memory portion (FIG. 11A).

According to some embodiments of the present invention, the one or more identification strings may be used by the peripheral device encryption engine to encrypt and/or digitally sign the data received from the host device (FIG. 11B).

According to further embodiments of the present invention, the peripheral device may include an interface slot and circuit to receive an external memory card (e.g. SD card) and may store data received from the host onto a card inserted into the slot. Data stored on the card may be encrypted and/or digitally signed using the encryption logic on the peripheral device (FIG. 11C). According to such embodiments, the reading of data stored on the card through the peripheral device may be limited such that the data may only be read through the peripheral device.

According to further embodiments of the present invention, the peripheral device may include one or more applications that when ran on a hosting device are adapted to present (e.g. show text, images and/or video and play sounds). The one or more applications may be adapted to receive and present data stored on the peripheral in an encrypted form. According to some embodiments of the present invention, the applications may be digitally signed, and the peripheral's interface circuit, encryption logic and/or controller may only decrypt and provide stored data to said applications. According to further embodiments of the present invention, a digitally signed application for which the peripheral may decrypt and provide data may be an internet application published by a trusted party.

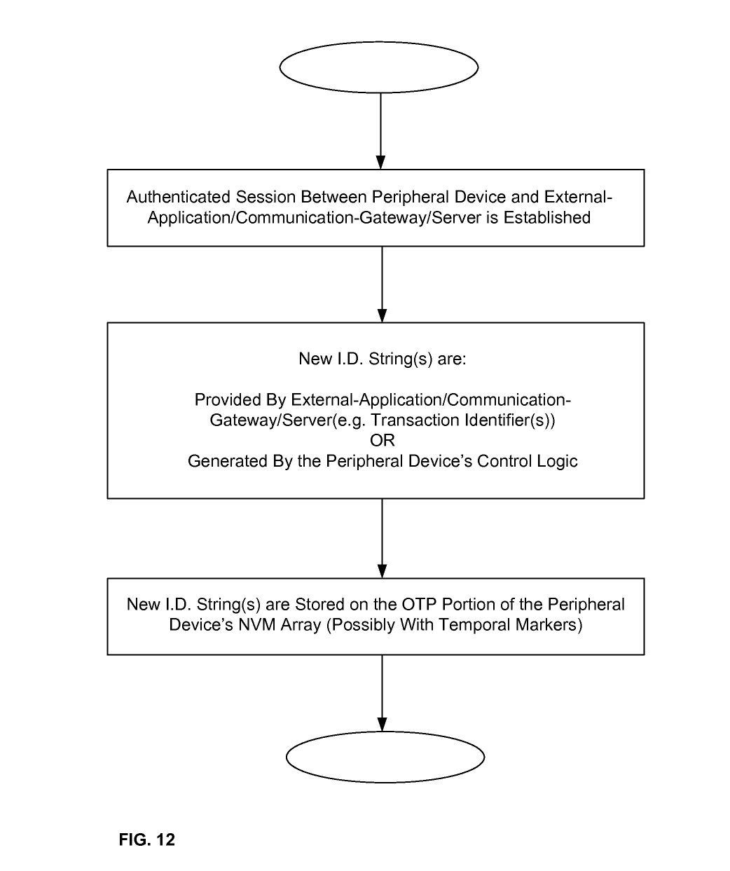

According to further embodiments of the present invention, one or more new identification strings may be added to the OTP portion of the memory array. The one or more new identification strings (e.g. transaction session identifiers) may be added during a communication session with an external application/gateway/server, and may be provided by the application/gateway/server. Alternatively, the one or more new identification strings may be generated by the peripheral control logic (FIG. 12). New identification strings may be stored along with time stamps or other temporal markers. According to some embodiments of the present invention, part of or the entire OTP memory portion may be blocked, for further writing to it, upon fulfillment of one or more predetermined threshold conditions (e.g. temporal, remaining storage, or other).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A Nonvolatile Memory (NVM) die for authenticating a communication session comprising:
a set of NVM cells;
a NVM control logic adapted to operate at least a portion of the NVM cells as One Time Programmable (OTP) NVM and to store one or more identification strings on the OTP NVM cells, wherein at least one of the stored strings is a substantially unique string correlated with said die; and
a NVM controller functionally associated with said NVM control logic, adapted to utilize the one or more identification strings stored on said OTP NVM as part of an authentication scheme.

2. The NVM die according to claim 1, wherein the substantially unique string at least partially contains a data set that is based on the serial number of the NVM die.

3. The NVM die according to claim 1, wherein the NVM controller is further adapted to utilize the one or more identification strings stored on the OTP NVM as part of an encryption and/or decryption scheme.

4. The NVM die according to claim 1, wherein the NVM control logic is further adapted to store one or more additional ID strings on the OTP NVM cells, wherein said one or more additional ID strings are part of a set of substantially unique strings correlated with a corresponding distributer of a set of dies.

5. (canceled)

6. (canceled)

7. (canceled)

8. A system for authenticating a communication session comprising:
a set of Nonvolatile Memory (NVM) cells;
a NVM control logic adapted to operate at least a portion of the NVM cells as One Time Programmable (OTP) NVM and to store one or more identification strings on the OTP NVM cells, wherein at least one of the stored strings is a substantially unique string correlated with said set of NVM cells; and
a NVM controller functionally associated with said NVM control logic; and
a host device functionally associated with said NVM controller, configured to access and utilize said one or more identification strings stored on said OTP NVM as part of an authentication scheme.

9. The system according to claim 8, wherein the substantially unique string at least partially contains a data set that is based on the serial number of the NVM die.

10. The system according to claim 8, wherein the host device is further configured to access and utilize the one or more identification strings stored on said OTP NVM as part of an encryption and/or decryption scheme.

11. The system according to claim 8, further comprising a device controller functionally associated with the NVM controller.

12. The system according to claim 11 wherein the device controller is further adapted to receive one or more biometric parameters of a user of the device; and
wherein the host device is functionally associated with device controller and is further configured to utilize said one or more biometric parameters, as one or more additional factors, as part of an authentication scheme.

13. The system according to claim 11, wherein the device controller functionally associated with the NVM controller is located on the interfaced host device.

14. The system according to claim 8, wherein the NVM control logic is further adapted to store one or more additional ID strings on the OTP NVM cells, wherein said one or more additional ID strings are substantially unique strings correlated with one or more of the host devices interfaced by the device.

15. (canceled)

16. (canceled)

17. The system according to claim 8, wherein the set of Nonvolatile Memory (“NVM”) cells is located on a gaming cartridge; and the host device is a gaming console.

18. The system according to claim 8, wherein the set of Nonvolatile Memory (“NVM”) cells is located on a media storage device; and the host device is a media player.

19. A method for authenticating a communication session comprising:
operating at least a portion of a set of Nonvolatile Memory (NVM) cells as One Time Programmable (OTP) NVM;
storing one or more identification strings on the OTP NVM cells, wherein at least one of the stored strings is a substantially unique string correlated with said set of NVM cells;
accessing said one or more identification strings; and
utilizing one or more of said identification strings as part of an authentication scheme.

20. The method according to claim 19, wherein utilizing of the one or more of the identification strings stored on the OTP is as part of an encryption and/or decryption scheme.

21. The method according to claim 19, wherein storing is of a substantially unique string at least partially containing a data set that is based on the serial number of the NVM die.

22. The method according to claim 19, wherein storing further comprises, storing one or more biometric parameters of a user; and
utilizing further comprises, utilizing said one or more biometric parameters, as one or more additional factors, as part of an authentication scheme.

23. The method according to claim 19, wherein utilizing further comprises Interfacing a host device; and
allowing a controller located on the host to utilize the one or more identification strings as part of an authentication scheme.

24. The method according to claim 19, wherein storing further comprises storing one or more additional ID strings that are substantially unique strings correlated with one or more host devices.

25. The method according to claim 19, wherein storing further comprises storing one or more additional ID strings that are part of a set of substantially unique strings correlated with said set's distributer.

26. (canceled)

27. (canceled)

28. (canceled)

29. (canceled)
